(19) United States
(12) Patent Application Publication
(10) Pub. No.: US 2004/0142791 A1
(43) Pub. Date: Jul. 22, 2004

(54) Auxiliary-range transmission for a motor vehicle

(76) Inventor: Ralf Dreibholz, Meckenbeuren (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/477,903

(22) PCT Filed: May 14, 2002
(86) PCT No.: PCT/EP02/05258

(30) Foreign Application Priority Data
May 18, 2001 (DE) 101 24 352.9

(51) Int. Cl. B60K 41/12

(52) U.S. Cl. 477/41

(57) ABSTRACT

An auxiliary-range transmission (1) for a motor vehicle is proposed which comprises at least one power-splitting stage (8) and at least one power-combining stage (6) and therebetween at least two drive trains (3, 9) disposed parallel to each other having each at least one shifting element (5, 10), there being situated in one of the drive trains (3) one continuously variable transmission (4) which can be implemented by a continuously variable adjustment of the ratio of the whole transmission (1) in a particular speed. A gear is changed here without interruption of tractive force and with a power reversal in the continuously variable transmission (4). During a range change a load transfer occurs on at least one shifting element (5, 10) of frictional type by an adjustment of ratio of the continuously variable transmission (4) simultaneous with the shifting of the shifting elements (5, 10).

The invention relates to an auxiliary-range transmission for a motor vehicle of the kind defined in detail in the preamble of claim 1.

Auxiliary-range transmission in which a power splitting is possible and which contain a continuously variable transmission in a power train which contributes to a remarkable improvement in the efficiency of a continuously variable transmission and makes a larger range of ratio possible.

Such an auxiliary-range transmission has been disclosed, for example, in German Patent DE 39 03 877 C1 where a transmission is described which comprises a four-shaft gear wheel planetary transmission and a continuously variably adjustable hydrostatic transmission disposed parallel therewith, the same as additional gear wheels, wherein shift toothed clutches implement several gears in each of which the hydrostatic transmission effects a continuously variable adjustment of the continuously variable ratio of the whole transmission. The gear is changed here at synchronous rotational speed of the shifting element to be engaged without interruption of the tractive force and with a power reversal in the continuously variable part.

At the synchronization point, a ratio correction becomes necessary, the ratio of the continuously variable transmission part being corrected by the control thereof and the variator being adjusted until reaching the synchronization point of the shifting element to be engaged. Afer locking the new shifting element, a torque is transmitted by the ratio being changed by one factor of the difference between a nominal and an actual value.

The ratio correction at the synchronization point, however, is disadvantageously inaccurate. Thus it is not ensured that the form-locking shifting element to is disengaged be fully unloaded after the shifting. Together with said circumstance, it further contributes to a poor shifting quality that when the connection of form-locking shifting elements is loosened under load, an intermittent change of torque occurs on the output.

From the practice, there are further known tests to design range changes, by means of clutches of frictional type, more tolerant of errors in case of hydrodynamic demands. To a change of range performed as powershift, the load transfer is introduced in the shifting elements prior to reaching the synchronization point of the clutch to be engaged. In this strategy of change of range, use should be made of the effect that in a clipping clutch its torque determines the torque in the drive train so that a ratio reversal in the variator cannot be felt.

However, the unloading of a first train, at a specific differential rotational speed on the shifting element to be engaged, has the consequence of a torque jump on the output resulting from the different ratio in the train concerned which causes the shifting comfort to suffer in the change of range.

The problem on which this invention is based is to make available an auxiliary-range transmission for a motor vehicle in which the shifting comfort is optimized in the range change while the loading of the shifting elements concerned is minimized and the range of adjustment of the continuously variable transmission is utilized to the utmost.

This problem is solved according to the invention with an auxiliary-range transmission having the features of claim 1.

In an inventive auxiliary-range transmission, where in a change of range a load transfer occurs on at least one frictionally designed shifting element due to an adjustment of the ratio of the continuously variable transmission simultaneous with shifting of the shifting elements, the load is distributed onto the shifting elements involved, so that at the right moment the shifting element to be disengaged is unloaded while the shifting element to be engaged is loaded and thus there prevails on the output as continuous as possible a change over of the transmission output torque.

The inventive auxiliary-range transmission makes possible in this manner a joitless range change and thus a great shifting comfort during the range change.

A particularly increased shifting comfort results here when the load transfer on the shifting element is simultaneous with the adjustment of the continuously variable transmission takes place at the synchronization point.

Of greater significance for the shifting comfort is also the inventively provided configuration of at least one of the participant shifting elements as frictional shifting element. Even through one of the participant shifting elements can also be form-lockingly designed, it is of particular advantage that all participant elements be of frictional type.

In a very advantageous development of the inventive auxiliary-range transmission, the ratio of the continuously variable transmission is adjusted during the change of the shifting elements in accordance with the properties of its variator in a manner such that the shifting element to be engaged undergoes at the synchronization point a previously calculated loading while the shifting element to be disengaged is unloaded.

By taking into account the specific properties of the variator of the continuously variable transmission, the accuracy of the load transfer on the shifting elements concerned is increased by means of variator adjustment and the shifting comfort is thus further improved.

When the ratio of the continuously variable transmission is adjusted so that the actual load torque of the variator at a calculated target point is changed to the new speed range while a load take over simultaneously occurs in the participant shifting elements involved, that is, for example, that the shifting element to the disengaged is moved to zero in the transmissible torque and the shifting element to be engaged is moved to the target torque to be transmitted, together with the attainment of a continuous transfer of the transmission output torque to the output, there is reliably prevented a discontinuance of an allowed variator ratio range like, for example, the driving in stops or the generation of an excessive slip.

To determine the properties of the variator, an empirical parameter can be constituted by the capacity for transmission of the shifting elements achieved in accordance with a certain position of the variator. The parameter of adjustment of the variator depends on the properties thereof. To determine said properties, it is possible, departing from an unloaded state where the nominal ratio corresponds to the actual ratio and no torque is transmitted by the variator, to produce the capacity for transmission by adjusting the variator in a certain direction, the torque transmitted here being empirically ascertainable by measurements. In this manner it is possible reliably to determine the properties of the variator and thus also the adjustment required by the variator during the change of range.

Other advantages and advantageous development of the invention result from the description that follows, from the drawing and from the claims. In the drawing:

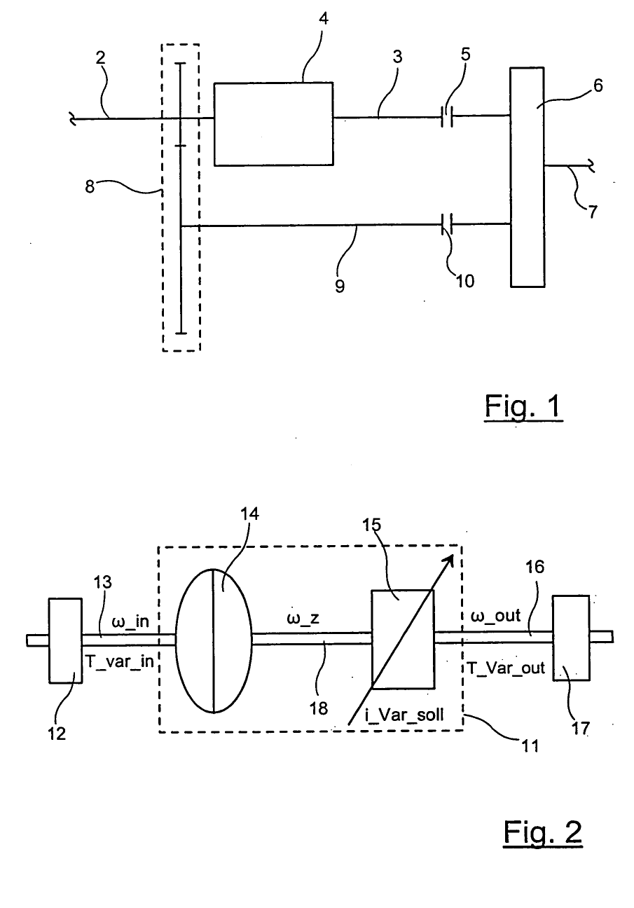

FIG. 1 is a basic sketch of an auxiliary-range transmission with a continuously variable transmission;

FIG. 2 is a pattern of the continuously variable transmission according to FIG. 1 reproducing the ratio, rotational speeds and torques; and

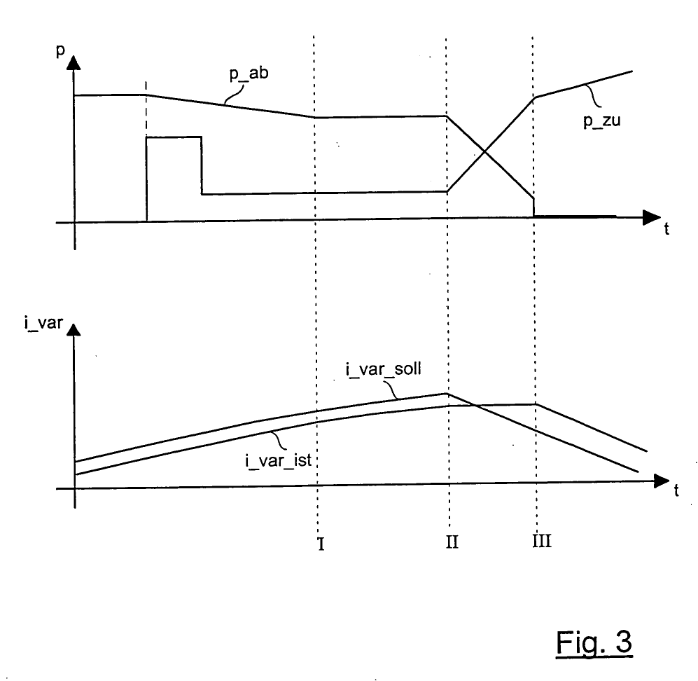

FIG. 3 is a diagram with pressure and ratio curves during change of range.

In FIG. 1 is a very schematized basic sketch of an auxiliary-range transmission 1 for a motor vehicle, preferably a passenger car, where an input shaft 2, which is connected with a prime mover not visible here, guides a first drive train 3 with a continuously variable transmission 4 to a planetary transmission that constitutes a power-combining stage 6 designed here as three-shaft planetary transmission of ger wheels. In alternative embodiments the power-combining stage 6 can also be implemented by other types of transmission.

The continuously variable transmission 4 represents in this case a CVT transmission, but in alternative embodiments it can also be a continuously variable transmission of other types with a variator such as a toroidal drive or a hydrostatic transmission.

The continuously variable transmission can be connected via a frictional shifting element 5 in the form of a friction clutch with a planetary transmission 6 which is connected with an output via an output shaft 7.

The power flow thus leads in one range from the input shaft 2 to the output shaft 7 via the first drive train 3 and the planetary transmission 6.

Via a power-splitting stage 8 representing here a gear wheel stage, the input shaft 2 is additionally connected with a second drive train 9 which can be connected with the planetary transmission 6 via a shifting element 10 likewise representing a friction clutch. A power shift to the second drive train 9 disposed parallel with the first drive train 3 is thus possible and in a second operating range the first drive train 3 with the continuously variable transmission 4 can be unloaded with a power flow via the second drive train 9, whereby the CVT transmission 4 can in turn achieve an improved efficiency.

In addition the spreading of the whole transmission enlarges with the option of several operating ranges.

In the auxiliary-range transmission 1 (shown), several gears can be implemented, in each of which the continuously variable transmission 4 produces a continuously variable adjustment of the ratio of the whole transmission 1. Here a gear is preferably changed at synchronous rotational speed and without interruption of the tractive force, a power reversal occurring in the continuously variable transmission 4.

By means of an adequate electronic control unit, such as an electronic transmission control existing anyway, during a change between the operating ranges described, it is possible to implement a load transfer on the friction clutches 5 and 10 in the synchronization point by adjustment of the ratio of the continuously variable transmission 4 simultaneous with the change of the friction clutches 5, 10.

The ratio of the continuously variable transmission 4 is adjusted according to the properties of a variator 11 of the continuously variable transmission 4, here of a CVT beveled-disc variator known per se. The variator 11 is adjusted to the extent that the shifting element to be engaged at the synchronization point undergoes a previously calculated load while the shifting element to be disengaged is unloaded. A computer unit of the electronic transmission control conveniently takes up the calculation of the load to be adjusted, that is, which torque has to be transmitted at the synchronization point after the load transfer, and the calculation is dependent on external forces, depending here on an engine torque acting upon the auxiliary-range transmission 1, via the input shaft 2, and a tractional resistance acting upon the transmission 1 via an output shaft 7, it being possible as substitution to determine the latter also by the output rotational speed gradient and the vehicle volume. The load is calculated separately here for each operating range of the auxiliary-range transmission 1.

The torques and rotational speeds, the same as the ratio thereof, appearing on the continuously variable transmission 4 are illustrated in the pattern shown in FIG. 2. In this general pattern, which can apply to all kinds of continuously variable transmissions, a numeral 12 symbolically reproduces the rotary mass existing in the output train before the variator 11 such as it abuts on an input shaft 13 of the variator 11. The variator 11, which in FIG. 2 is also only symbolically indicated, comprises a slip-torque transmitting element 14 in the form of a converter which, via a shaft 18, is connected with a continuously variable ratio-adjusting device 15. On an output shaft 16 of the variator 11, an output rotary mass is symbolically reproduced with a numeral 17.

The pattern in FIG. 2 illustrates the torque-dependent difference between a nominal ratio i_var_soil and an actual ratio i₁₃ var₁₃ ist of the variator 11 which is also to be understood from the diagram in FIG. 3.

The nominal ratio i_var_soll and the actual ratio i_var_ist of the variator 11 are identical only in the unloaded state. Due to the fact that a torque can only be transmitted by slip, divergences of rotational speed and thus of ratio, do occur.

In the loaded state, when a torque is produced in the converter 14, a difference results between the nominal ratio i_var_soll and the actual ratio i_var_ist, the actual ratio i₁₃ var_ist corresponding to the ratio of an input rotational speed ω₁₃ in on the input shaft 13 of the variator 11 to an output rotational speed ω₁₃ out on the output shaft 16 of the variator 11.

By presetting the nominal ratio i_var_soll and corresponding adjustment of the ratio-adjusting device 15, a differential rotational speed is produced between a rotational speed ω_z of the shaft 18 connecting the converter 14 and the ratio-adjusting device 15 and the input rotational speed ω_in in the input shaft 13. The torque T_var_in applied to the input of the variator 11 and dependent on the rotational speeds ω₁₃ z, ω_in, yields as product with the nominal ratio i₁₃ var_soll, an output torque T_var_out of the variator 11.

In the range change in the synchronization point, the load torques of the participant shifting elements 5, 10 depend on external torques like engine torque and tractional resistance, the same as on the presetting of the nominal ratio i_var_soll of the variator 11. The load transfer on the shifting elements 5 and 10 can thus be brought about by the adjustment of the variator 11.

Since the parameter of the adjustment depends on the properties of the variator, it has been determined in tests under consideration which transmission torque results during certain variator adjustment. The transmission capacity of the shifting elements 5, 10 thus determined, according to a certain variator adjustment constitutes an empirical parameter for determining the properties of the variator which enter in a servo control of the ratio adjustment of the variator 11 and are taken into account during adjustment of the variator 11 for change of range.

The servo control of the ratio adjustment serves to keep the control errors low and to improve the dynamics and is an existing part of a ratio regulation of a variator which has adequate control means for said purpose. In a manner known already, the servo control of the ratio adjustment in the CVT transmission 4 (shown here) can comprise a characteristic field for the nominal pressure ratios on both disc sets of the variator depending on ratio and load torque.

For reducing divergences this servo control can take into account, in addition, the dependence of the variator ratio on actual operating state parameters such as transmitted torque, actual variator ratio, rotational speeds, temperature, etc.

The variator 11 is now adjusted so that the shifting element to be engaged is loaded precisely as calculated while the shifting element to be disengaged is unloaded simultaneously. Depending on engine torque and tractional resistance, the reversal point alters a different load torque of the variator for the two ratio ranges. During a load take-up in the participating shifting elements 5, 10, the actual load torque of the variator is brought to the new speed range by adjusting the ratio to a calculated target value.

In the auxiliary-range transmission 1 (shown here), it is provided that the variator 11 and the shifting elements 5, 10 are simultaneously adjusted only when the dynamic characteristics, relative to the variator adjustment and the clutch adjustment are analogous. Dynamic characteristics is here understood as the dependence by time unit between the presetting of a ratio and the reaction thereto which is affected, for example, by the inertia of electrical adjusting elements. The dynamics of variator and shifting elements is designated as analogous when a time constant of the adjustment of the variator and a time constant of the adjustment of the shifting elements are within a specific presettable range.

In the case of an element to be adjusted, be it the variator 11 or one of the shifting elements 5 or 10, slower than the other elements; all elements are equally slowly designed or the corresponding quicker element is retarded.

Referring to FIG. 3, it illustrates the characteristics of the pressure curves of the shifting elements 5 and 10, the same as of the ratio i_var of the variator 11 during a range change, are reproduced with p_zu designating the pressure curve during the control of a friction clutch to be engaged and with p_ab designating the pressure curve in the course of time of a friction clutch to be disengaged. It can be seen here that in a range, which per time unit is close before the time point iof introduction of the range change, the shifting element to be engaged must be prefilled when it represents a hydraulic clutch in order to ensure a quick reaction to a demand for a gear shift. To this end, the pressure p_zu of the clutch to be engaged is briefly accelerated.

At the synchronization point II, the variator is adjusted simultaneously by change of the standard of the nominal ratio i_var_soll, disengagement of the shifting element to be disengaged by lowering the appertaining pressure p_zu and engagement of the new shifting element by accelerating its control pressure p_zu. The relevant standard can optionally result already earlier so that reaction under different delay characteristics of the participant elements occurs at the same time.

After the load transfer, which terminates at a moment III, the new shifting element is closed in order to reliably prevent slipping.

In the instant design of the auxiliary-range transmission 1 during the period of time of the range change, a superposed engine rotational speed regulation is deactivated, since during the range change the total ratio remains constant. The moment of freezing the superposed engine rotational speed regulation is selected according to the actual adjustment gradient and the time characteristics of the variator control, thus representing nearly the starting point iof the range change. In other words, the regulation of the engine rotational speed is frozen when the associated computer unit detects on the basis of continuous calculations that the differential rotational speed in the shifting element to be engaged tends toward zero and the variator 11 terminates its adjustment with its known dynamic characteristics so that the shifting element still reaches the synchronization point during the given inertia of the system. The result of this is that the variator runs damped to the synchronization point due to the inertia of its adjustment device.

Alternatively, during the range change, it is continuously possible to invert the action of the superposed regulation circuit or the regulator connected with the superposed engine rotational speed regulation. The inversion can here result by multiplication of the regulator output by a parameter whose value continuously changes in the course of time within the period of range change from “+1” to “−1” or viceversa.

At the moment m of termination of the range change, the superposed control circuit has to be modulated jolt-free by setting to zero the sum of the control components during the actual control difference.

Reference Numerals

1 auxiliary-range transmission

2 input shaft

3 first drive train

4 continuously variable transmission

5 frictional shifting element, friction clutch

6 gear wheel planetary transmission

7 output shaft

8 gear wheel ratio step

9 second drive train

10 frictional shifting element, friction clutch

11 variator

12 rotary mass

13 input shaft of the variator

14 slip-torque transmitting element, converter

15 ratio adjusting device

16 variator output shaft

17 rotary mass

18 shaft

ω_in rotational speed of the variator input shaft

ω_z variator rotational speed

ω_out rotational speed of the variator output shaft

i_var variator ratio

i_var_ist actual ratio of the variator

i_var_soll nominal ratio of the variator

p_ab pressure curve of the shifting element to be disengaged

p_zu pressure curve of the shifting element to be engaged

t time

T_var_in variator input torque

T_var_out variator output torque

1. Auxiliary-range transmission for a motor vehicle comprising at least one power-splitting stage (8) and at least one power-combining stage (6) and therebetween at least two drive trains (3, 9) disposed parallel to each other having each at least one shifting element (5, 10), there being situated in one of said drive trains (3) one continuously variable transmission (4) by means of which can be implemented a continuous adjustment of the ratio of the whole transmission (1) at one relevant speed, a gear change occurring without interruption of tractive force and with a power reversal in said continuously variable transmission (4), characterized in that during a change of range a load transfer results on at least one frictionally designed shifting element (5, 10) by adjustment of the ratio of said continuously variable transmission (4) carried out simultaneously with the change of said shifting elements (5, 10).

2. Auxiliary-range transmission according to claim 1, characterized in that the load transfer occurs at the synchronization point.

3. Auxiliary-range transmission according to claim 1 or 2, characterized in that said shifting elements (5, 10) are each frictionally designed.

4. Auxiliary-range transmission according to any one of claims 1 to 3, characterized in that the ratio of the continuously variable transmission (4) is adjusted during the shifting of said shifting elements (5, 10) in accordance with the properties of a variator (11) in a manner such that said shifting element (5 or 10) to be engaged undergoes at the synchronization point a calculated load while said shifting element (10 or 5) to be disengaged is unloaded.

5. Auxiliary-range transmission according to any one of claims 1 to 4, characterized in that the ratio of said continuously variable transmission (4) is adjusted during load transfer in said participant shifting elements (5, 10) in a manner such that the actual load torque of said variator (11) is changed at a calculated target point in the new driving range.

6. Auxiliary-range transmission according to claim 4 or 5, characterized in that the load to be adjusted of said shifting element (5 of 10) to be engaged at the synchronization point is calculated according to external forces.

7. Auxiliary-range transmission according to claim 6, characterized in that an engine torque and a tractional resistance are included as external forces in the calculation of the load to be adjusted of said shifting element (5 of 10) to be engaged at the synchronization point.

8. Auxiliary-range transmission according to any one of claims 4 to 7, characterized in that the transmission capacity of said shifting elements (5, 10) achieved according to a specific variator adjustment constitutes an empirical parameter for detecting the properties of said variator (11).

9. Auxiliary-range transmission according to any one of claims 1 to 8, characterized in that a ratio regulation of said variator has means for servo control of the ratio adjustment.

10. Auxiliary-range transmission according to claim 9, characterized in that the ratio adjustment of said variator (110 is servo controlled depending on actual operating state parameters of said transmission (1).

11. Auxiliary-range transmission according to any one of claims 1 to 10, characterized in that ratios of said continuously variable transmission (4) and of said shifting elements (5, 10) are simultaneously adjusted when the dynamic characteristics of variator adjustment and shifting element adjustment are at least analogous.

12. Auxiliary-range transmission according to any one of claims 1 to 11, characterized in that a regulator for said continuously variable transmission (4) connected with a superposed engine rotational speed regulation is deactivated during the period of time of the range change.

13. Auxiliary-range transmission according to any one of claims 1 to 11, characterized in that a regulator for said continuously variable transmission (4) connected with a superposed engine rotational speed regulation is continuously inverted in its action during the period of time of the range change.

14. Auxiliary-range transmission according to claim 13, characterized in that the inversion results by a multiplication of the regulator output by a parameter that changes within the period of time of range change from “+1” to “−1” or viceversa.

15. Auxiliary range transmission according to any one of claims 1 to 14, characterized in that said continuously variable transmission (4) is a CVT transmission, a toroidal transmission or a hydrostatic transmission.
